(19) United States
(12) Patent Application Publication
(10) Pub. No.: US 2003/0123663 A1
(43) Pub. Date: Jul. 3, 2003

(54) Method and apparatus for preventing unauthorized copying of screen images

(76) Inventors: Michael A. Epstein, Spring Valley, NY (US); Peter J. Janssen, Scarborough, NY (US); Douglas A. Stanton, Ossining, NY (US)

Correspondence Address: PHILIPS ELECTRONICS NORTH AMERICAN CORP, 580 WHITE PLAINS RD, TARRYTOWN, NY, 10591, US

(21) Appl. No.: 10/033,959

(22) Filed: Dec. 27, 2001

(51) Int. Cl. H04N 7/167

(52) U.S. Cl. 380/214

(57) ABSTRACT

A method and apparatus for introducing alterations in video screen images includes projecting recordable but not viewer visible, colored bars, stripes or the like into the video screen images using randomly selected scanning sequences and/or scanning rates, each of which are selected when a known event, such as a known period of time or change in the content of the video screen images, occur.

### RELATED APPLICATION

Commonly-assigned, copending U.S. patent application, Ser. No. ______, entitled “APPARATUS FOR PROVIDING MULTI-SPECTRAL LIGHT FOR AN IMAGE PROJECTION SYSTEM”.

### FIELD OF THE INVENTION

The present invention relates to the field of video imaging and, in particular, to a method and apparatus for preventing the unauthorized copying of screen images.

### BACKGROUND OF THE INVENTION

Image projection in cinema theaters or home theaters, is well known in the art. In cinema theaters, projection devices project images on a screen by passing a white light source through images captured on a film-type media. FIG. 1 illustrates a conventional film-type front-projection system. In this system, a white light source 110 illuminates a shutter 115, which interrupts the passage of white light at a nominal rate of 48 frames per second. When the shutter 115 is open, white light from the light source 110 is projected onto a film 120. The film 120 is composed of a plurality of images contained in frames, 121, 122, 123, 124, 125, etc. As is well known, each frame contains a slightly different image, which when projected in sequence creates the perception of motion. In this illustrative example, the image contained on frame 123 is projected onto a lens 130 when light from the light source 110 passes through the shutter 115. The frames are advanced in synchronism to the operation of the shutter 115. The lens 130 then projects the images on a screen 140, which are observable by viewers as the images are reflected from screen 140. The images reflected from screen 140 can also be captured by a video recording device (not shown) pointed at screen 140, which allows copying of the projected video images.

In conventional projection technology, images are exposed typically at a rate of 48 frames per second. Further, each image is double flashed to prevent artifacts of the image. Hence, images are projected at a nominal rate of 24 frames per second. Video recording devices typically record images at 30 frames per second. While there is a difference in the rate of projection and the rate of capture, the difference is not observed by the viewer as the camera integrates out discrepancy between the two different frame rates. Also video recording device capture frame rates can be adjusted to match the projection frame rate.

Unauthorized copying of screen projected video images, such as in cinema theaters, using video recording or camcorder devices is a significant problem for the studios, producers, distributors, and actors. Each unauthorized recording can be translated into lost ticket sales, lost video/DVD rentals and sales. As camcorder devices become more compact and their reproduction quality increases, their concealment and use within a darkened theatre becomes increasingly easier and more plausible. Thus, unauthorized copying of screen projected video images is likely to increase, since movie theater owners cannot search patrons entering their theater without causing great resentment, and loss of sales. Accordingly, a method is needed that adversely effects an image captured on a recording device without adversely effecting the video screen images observed by the viewing public.

### SUMMARY OF THE INVENTION

The method and apparatus disclosed herein introduces alterations in video screen images collected and captured by a video recording device. In accordance with the principles of the invention, colored bars, stripes or the like are projected into video screen images using randomly selected scanning sequences, each of which are selected when a known event, such as a known period of time or change in the content of the video screen images, occur. In one aspect of the invention, alterations and interference can be introduced by altering the scanning rate, for a finite period of time, of the projected bars of colored light based on the content of the video screen images. For example, the scanning rate can be slowed from a nominal scanning rate when the content of the video screen images has a limited amount of motion.

### BRIEF DESCRIPTION OF THE DRAWINGS

In the drawings:

FIG. 1 illustrates a conventional mechanical film-type front projection system;

FIG. 2a illustrates an exemplary reflective light projecting system for introducing alterations or interference in video screen images in accordance with the principles of the present invention;

FIG. 2b illustrates an exemplary transmissive light projecting system for introducing alterations or interference in video screen images in accordance with the principles of the present invention;

FIG. 3a illustrates an exemplary embodiment of a multi-spectral light source in accordance with the principles of the present invention;

FIG. 3b illustrates an exemplary projection scanning sequence using the multi-spectral light source illustrated in FIG. 3a;

FIG. 3c illustrates an exemplary reflective light projecting system using the multi-spectral light source illustrated in FIG. 3a;

FIG. 3d illustrates an exemplary transmissive light projecting system using the multi-spectral light source illustrated in FIG. 3a;

FIGS. 4a-4c illustrate the multi-spectral light source illustrated in FIG. 3a at sequentially different times to illustrated a method for producing scrolling red, green and blue light bars or stripes, which can be projected by this light source;

FIGS. 5a-5e illustrate an exemplary scanning sequence in accordance with the principles of the invention using the multi-spectral light source of FIG. 3a;

FIGS. 6a-6e illustrate a second exemplary scanning sequence in accordance with the principles of the invention using the multi-spectral light source of FIG. 3a;

FIGS. 7a-7e illustrate another exemplary scanning sequence in accordance with the principles of the invention using the multi-spectral light source of FIG. 3a; and

FIG. 8 illustrates a flow chart of exemplary processing to introduce interference in video screen images in accordance with the principles of the invention.

It is to be understood that these drawings are solely for purposes of illustrating the concepts of the invention and are not intended as a definition of the limits of the invention. It will be appreciated that the same reference numerals, possibly supplemented with reference characters where appropriate, have been used throughout to identify corresponding parts.

### DETAILED DESCRIPTION OF THE INVENTION

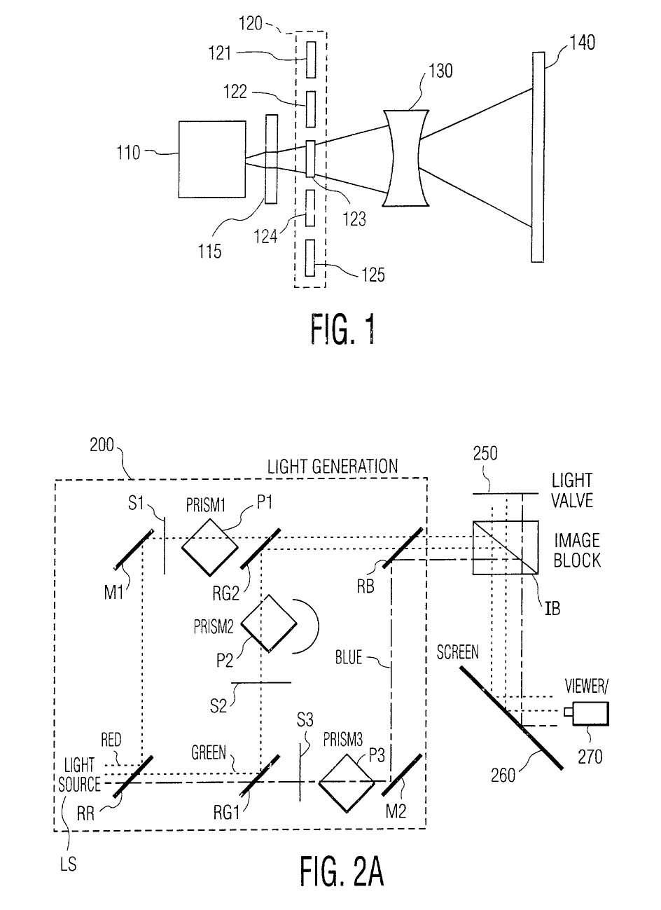

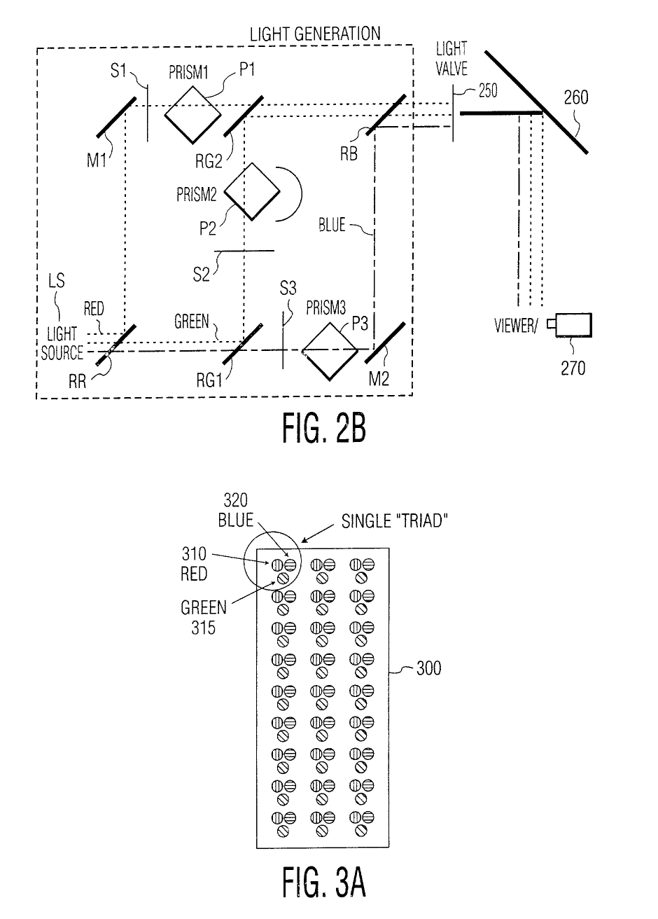

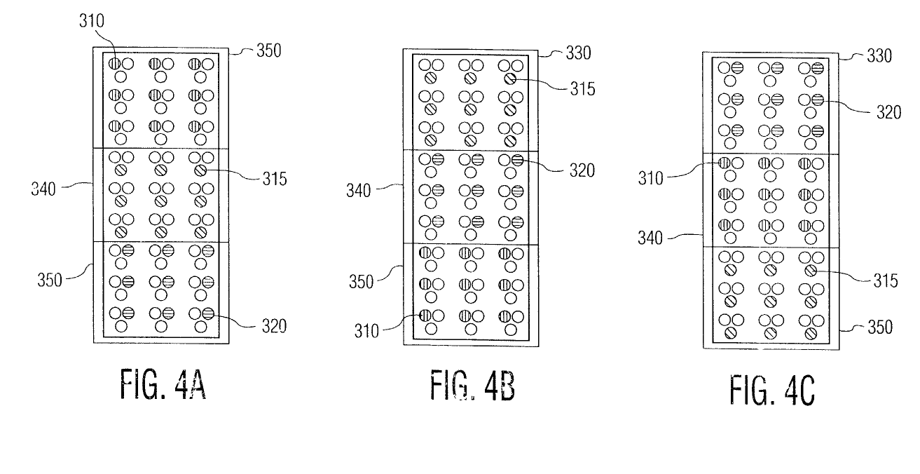

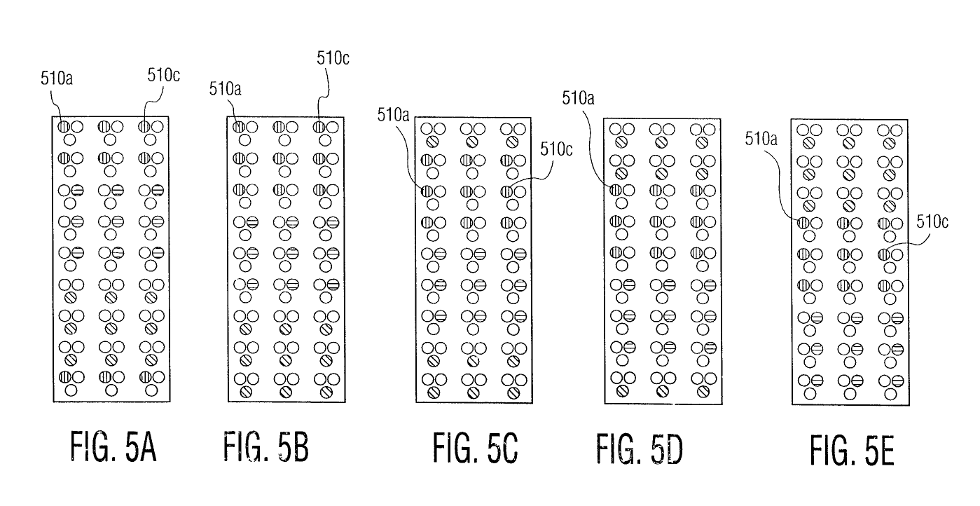

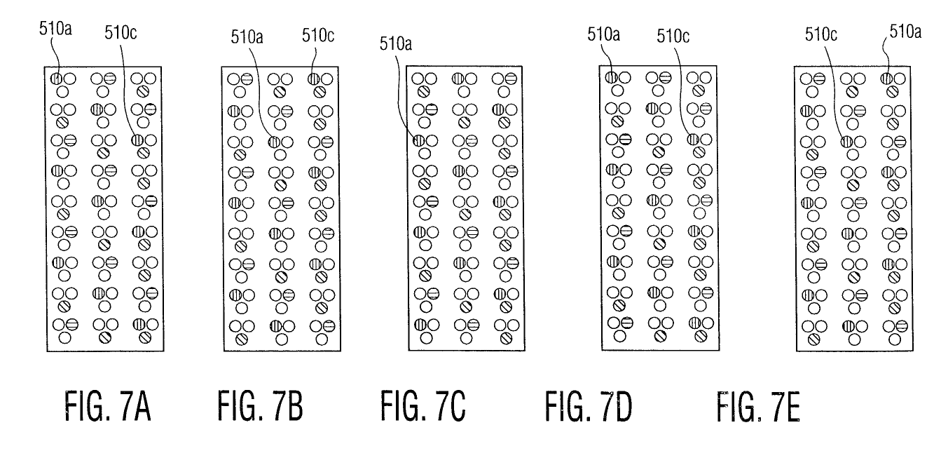

FIG. 2a illustrates an exemplary reflective light projecting system for introducing alterations or interference in video images projected onto a screen, such as movies shown in cinemas, in accordance with the principles of the present invention. In the illustrated system, a multi-spectral light source 200 generates a sequence of bars, stripes, or other shares of colored light e.g., red, green and blue onto a light valve 250. The light valve 250 adjusts the level of colored light, which is then projected onto a screen 260 concurrently with the projected video screen images for a finite period of time. The period of time is selected such that the bars of colored light are not visible in the video screen images by a viewer, but are visible when recorded on a recording device. The bars of colored light are projected onto the screen 260 in accordance with a randomly selected scanning sequence. Examples of such scanning sequences are illustrated in FIGS. 5a-5e, 6a-6e and 7a-7e, using a preferred multi-spectral light source to be described further on. Hence, the light source 200 may, for a finite period of time, project bars of red, green and blue light onto the light valve 250 in accordance with the scanning sequence illustrated in FIGS. 5a-5e. At a known event, such as the lapse of a pre-determined time interval, content of a video image scene, etc., the light source 200 may, for another finite period of time, project bars of red, green and blue light onto the light valve 250 in accordance with the scanning sequence illustrated in FIGS. 7a-7e. The process of randomly selecting alternative scanning sequences continues after the occurrence of known events. For example, a scanning sequence may be changed when the content of the video screen images contains a known level of a single color, or when the presence of light invisible to the eye is detected. Alterations and interference can also be introduced into video screen images by altering the scanning rate of the projected bars of colored light, for a finite period of time, based on the content of the video screen images. For example, the scanning rate can be slowed from a nominal scanning rate when the video screen images content has a limited amount of motion.

Accordingly, additional images (colored bars, stripes and the like) are projected onto the screen 260, in alternating patterns concurrently with the video screen images that are invisible to the viewer but are captured on a video recording device 270. When the video screen images recorded on the video recording device 270 are played back, the colored bars, stripes and the like projected onto the screen 260, are observable by the viewer. Hence, the recorded video is difficult or impossible to view in an enjoyable manner.

Alterations or interference can be introduced in video screen images in accordance with the principles of the present invention using well known light projecting systems, which operate by dividing images into component elements, i.e., pixels, and projects the individual pixels using differing levels of, red, green and blue light color to render a correct color image. Such light projecting systems are commonly used in rear-projection home theaters. The reflective light projecting system of FIG. 2a illustrates such a light projecting system. In this system, the multi-spectral light source 200 includes an intense white light source LS, such as an arc lamp, to generate white light that may be decomposed into three primary color components, in this case red green and blue light using the following elements. The first optical element struck by the white light is a dichroic filter RR. Dichroic filters are used in the art for reflecting a desired color of light and passing all other colors of light. The filter RR is placed at about a 45 degree angle so as to reflect the red component of the white light by 90 degrees through a series of additional optical elements. The first one of these elements is a conventional mirror M1 that changes the direction of the red light by about 90 degrees. The red light is then shaped by an optical slit element denoted by the numeral S1 that creates a bar of red light. This bar of red light then passes through a rotating prism P1 so as to cause the red bar of light to scroll across the light valve 250. The scrolling action can progress in many orientations across the light valve e.g. horizontally, vertically or diagonally, but is usually scrolled vertically from top to bottom. Prior to reaching the light valve 250, the scrolling bar of red light passes through two other dichroic filters RG2 and RB that respectively reflect only green and blue light. The scrolling red bar of light then passes through an image block IB and onto the reflective light valve 250. The light valve 250 modulates the red light bar with red pixel information to form the red portion of an image which is then reflected back to the screen 260. The screen 260 then reflects the red portion of the image to the observer.

The green component of the white light passes through the filter RR and is reflected via a dichroic filter RG1 that reflects only green light and allows the blue light to pass. The green light, which has now changed direction by 90 degrees, passes through a second optical slit element S2 and a second rotating prism P2. The second slit S2 and prism P2 form a scrolling bar of green light in manner similar to the red bar. The scrolling bar of green light is then reflected by the dichroic filter RG2 to join the green scrolling bar with the red scrolling bar. The two bars do not overlap and maintain their relative position on the light valve via coordinated controls in the rotating prisms P1 and P2. The green bar then passes through the dichroic filter RB to the image block IB and onto the reflective light valve 250. The light valve 250 modulates the green light with green pixel information to form the green portion of the image, which is then reflected back to the screen 260. The screen 260 then reflects the green portion of the image to the observer.

The blue component of the white light passes through the filters RR and RG1 where it is shaped by a third optical slit element S3 into a bar of blue light. This bar of light is then scrolled via a third prism P3 in a manner similar to the red and green light. The bar of blue light then reflects off a second conventional mirror M2 and the dichroic filter RB to the image block IB and onto the reflective light valve 250. The light valve 250 modulates the blue light with blue pixel information to form the blue portion of the image, which is then reflected back to the screen 260. The screen 260 then reflects the blue portion of the image to the observer. More specifically, the scrolling bar of blue light is coordinated with the green and red light so that none of the bars overlap and the entire light valve is illuminated. As the different bars of light progress across the light valve 250, different pixel information is used to modulate the different light colors so that an integrated color image appears to the observer.

FIG. 2b shows another type of light projecting system which can be used for introducing alterations or interference in video screen images in accordance with the principles of the present invention. This system is commonly known as a transmissive light projecting system. This system uses substantially the same type of multi-spectral light source for generating colored light bars as the reflective light projecting system described in FIG. 2a. The difference in this system is that the light valve 250 modulates light as it passes therethrough to the screen 260, which reflects the image to an observer.

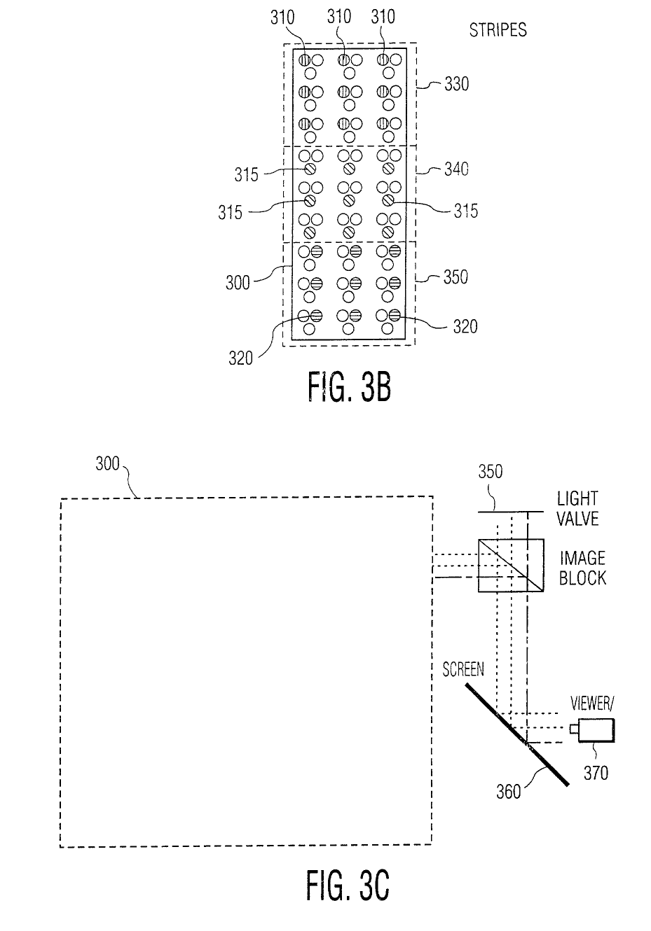

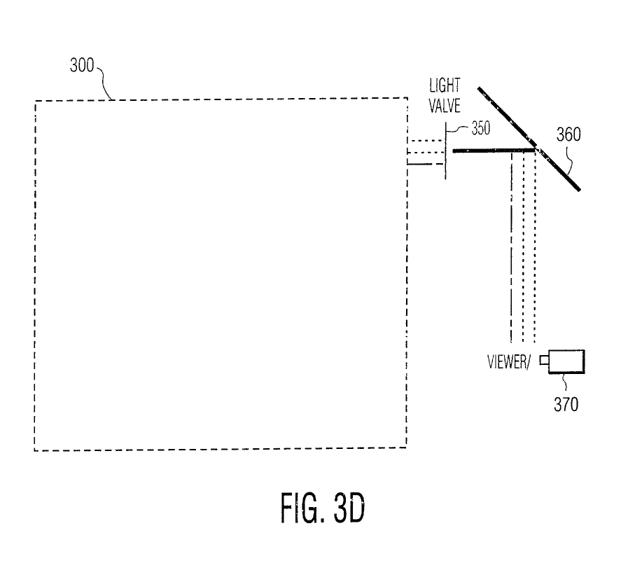

FIG. 3a illustrates an exemplary embodiment of a multi-spectral light source 300 according to the principles of the present invention. The details of the multi-spectral light source 300 are described in the above-mentioned related copending patent application, entitled “APPARATUS FOR PROVIDING MULTI-SPECTRAL LIGHT FOR AN IMAGE PROJECTION SYSTEM” filed concurrently herewith. The light source 300 is preferred for use in either a reflective or transmissive light projecting system for introducing alterations or interference in video screen images according to the present invention. The light source 300 comprises an array of light-emitting diodes (LED) groups or triads. Each LED triad includes a red LED 310, a green LED 315 and a blue LED 320, all of which are conventional in design and operation. The LEDs of each triad may be arranged in a triangular manner as shown, or in any other suitable arrangement.

FIG. 3b illustrates an exemplary projection sequence using the multi-spectral light source 300 of FIG. 3a. In this example, a plurality of rows are grouped together as a single controllable unit. This grouping provides a wider bar or stripe of projected color light when the single colored LED is illuminated. In this case, the first three illustrated rows, represented as unit 330, are controllable as a single unit. Similarly, rows 4-6, represented as unit 340, and rows 7-9, represented as unit 350, are individually controllable. Accordingly, in this exemplary embodiment each red LED 310 contained in unit 330 is illuminated while each green LED 315 contained in unit 340 and each blue LED 320 contained in unit 350 is illuminated for a known period of time.

FIGS. 4a-4c show the light source 300 at sequentially different times to illustrated a method for producing scrolling red, green and blue light stripes projected by light source 300 embodied in FIG. 3a. In FIG. 4a, each red LED 310 in unit 330 is illuminated and not illuminated in units 340 or 350. Similarly, each green LED 315 is illuminated in unit 340, while each blue LED 320 in unit 350 is illuminated. FIG. 4b depicts a next stage in the projection sequence, in that each red LED 310 in unit 350 is illuminated and not illuminated in units 330 or 340. Similarly, each green LED 315 is illuminated in unit 330, while each blue LED 320 is illuminated in unit 340. FIG. 4c depicts a further next stage in the projection sequence, in that each red LED 310 in unit 340 is illuminated and not illuminated in units 330 or 350. Similarly, each green LED 315 is illuminated in unit 350, while each blue LED 320 is illuminated in unit 330.

In this exemplary projection sequence, the red, green and blue color bars progress from a bottom of light source 300 to a top of light source 300. As would be appreciated, the red, green and blue color bars can also proceed from a top of the light source to a bottom of the light source. Although the rows are shown progressing three at a time, it is also contemplated that the rows can progress one row at a time or more than three rows at a time. Also, there may be gaps provided between the bars or stripes.

FIGS. 5a-5e illustrate one of the exemplary scanning sequences mentioned earlier using the light source of FIG. 3a. FIG. 5a depicts an initial order of the illumination of the LEDs of light source 300. FIG. 5b depicts the order of illuminated LEDs, in which illuminated LEDs, denoted as 510a, 510c, representative of two illuminated LEDs, are sequenced in a top-to-bottom manner. As illustrated, LEDs, 510a, 510c are now shown in a second row of an exemplary 3×9 light source 300. In FIG. 5c, LEDs 510a, 510c are shown in a third row of the exemplary 3×9 light source 300. FIGS. 5d and 5e further illustrate the top-to-bottom sequence of LED illumination. In this case, LEDs 510a, 510c, are shown illuminated in rows 4 and 5, respectively of light source 300. Accordingly, as the illumination of LEDs progress through the rows of light source 300, horizontal bars or stripes of colored light are projected onto the light valve illustrated in FIG. 3c.

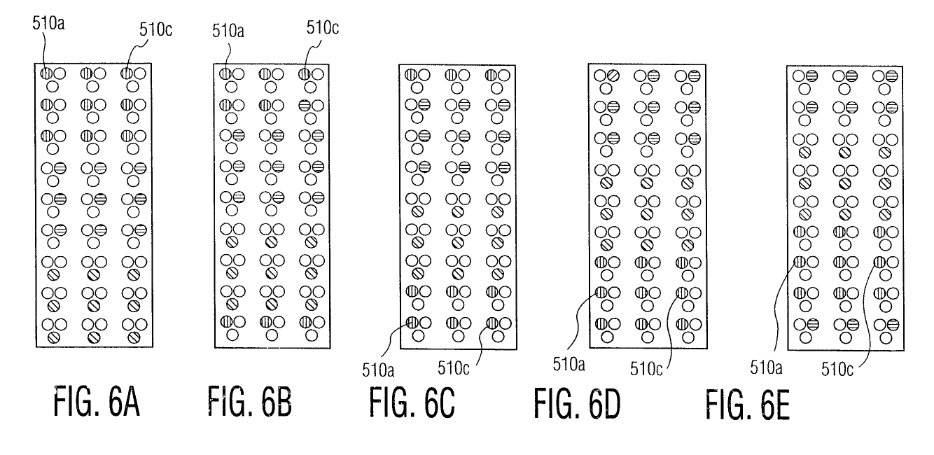

FIGS. 6a-6e illustrate another exemplary scanning sequence using the light source of FIG. 3a. In this illustrative sequence, the sequence of outputting colored bars of light is reversed as the order of illuminating LEDs in the individual rows is changed. In this example, FIG. 6a illustrates illuminated LEDs 510a, 510c in a second row of light source 300. FIG. 6b illustrates illuminated LEDs 510a, 510c in a first row of light source 300 and FIG. 6c illustrates illuminated LEDs 510a, 510c in a last row of light source 300. Similarly, FIGS. 6d and 6e illustrate illuminated LEDs 510a, 510c in rows 8 and 7, respectively, of light source 300. Accordingly, in this example, the activation, and consequently, the scan sequence, is altered such that the order of outputting bars of colored light is in a bottom-to-top order. Corresponding changes must also take place in the light valve addressing to create a correct projected image.

FIGS. 7a-7e illustrate still another exemplary scanning sequence using the light source of FIG. 3a. In this illustrative example, a different LED is illuminated in each triad in a row. In this case, the shifting of illuminated LEDs occurs within the columns of light source 300. More specifically, LED 510a is depicted as being illuminated in a first row and a first column of light source 300 and LED 510c is depicted as being illuminated in a third row and a third (last) column of light source 300 and 510c is depicted as being illuminated in the third row second column of the light source 300. FIG. 7b illustrates the next stage in the illuminated LED configuration. In this example, LED 510a is depicted as being illuminated in a first row and a third (last) column of light source 300. FIG. 7c illustrates a further next stage of the illuminated LED configuration. In this example, illuminated LED 510a is located in a first row and a second column of light source 300 and LED 510c is located in a third row and a first row of light source 300. FIGS. 7d and 7e further illustrate the shifting pattern of illuminated LEDs. In these example, LED 510a is depicted first in first column and then in a last column, respectively. Thus, diagonal bars or stripes of color light are projected onto the light valves 350 depicted in FIGS. 3c and 3d. As would be appreciated, vertical stripes of color light can be output by selecting, and shifting, similarly colored LEDs within the columns of light source 300. Multiple LEDs could be selected to have wider or narrower bars of colored light as might be needed by various light valves or optical requirements.

The multi-spectral light source 300 of FIG. 3a may be used in a reflective light projecting system as illustrated in FIG. 3c or in a transmissive light projecting system as illustrated in FIG. 3d, for introducing alterations or interference in video screen images. In the illustrated systems, light source 300 projects bars of color light on to light a valve 350. The light valve 350 adjusts the level of colored light, i.e., red, green and blue, which are then projected onto a screen 360. The scanning sequence of project the bars or stripes of color light is selected from a plurality of sequences, as illustrated by the examples shown in FIGS. 5a-5e, 6a-6e and 7a-7e discussed above. Hence, light source 300 may for a finite period of time may project bars of red, green and blue light using the sequence presented in FIGS. 5a-5e. At the determination of a known event, such as the lapse of a pre-determined time interval, content of a scene image, etc., an alternative sequence, for example the sequence illustrated in FIG. 7a-7e, is then used to project bars of red, green and blue light onto the light valve 350.

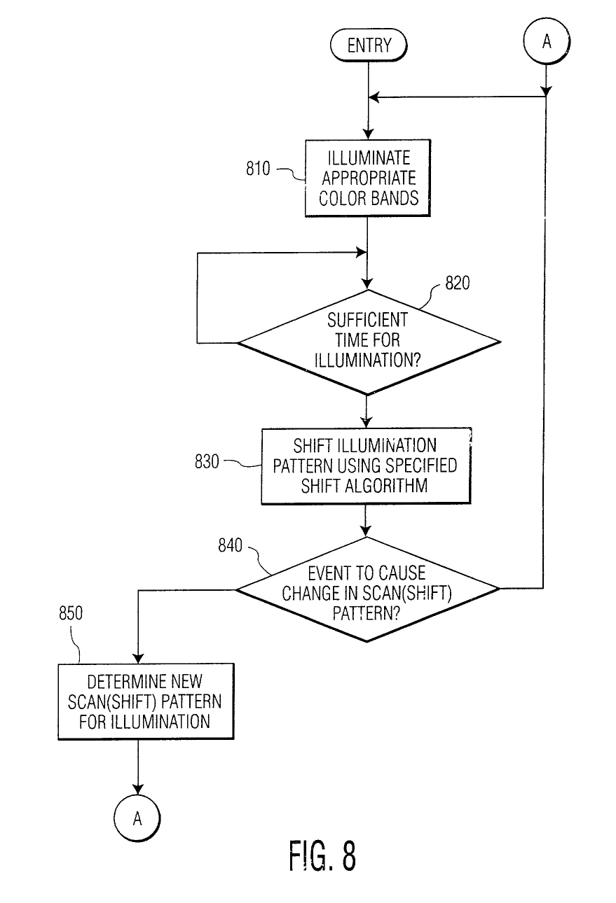

FIG. 8 illustrates an exemplary flow chart of the processing necessary to control and alter the scan sequence of illumination in accordance with the principles of the invention. At block 810, bars or stripes of color light are projected using known techniques. For example, referring to FIG. 4a, red LEDs 310 in unit 330, green LEDs 315 in unit 340 and blue LEDs 320 in unit 350 are illuminated to provide horizontal bars of colored light. At block 820 a determination is made as to whether each LED has been illuminated for a sufficient period of time. If the answer is in the negative then the process continues to wait until the desired period of time has been achieved. If the answer, however, is affirmative, then the illumination pattern is changed in accordance with a known sequence, at block 830.

At block 840, a determination is made as to whether an event has occurred to cause a change in the current projection sequence. If the answer is in the negative, then the illumination pattern determined at block 830 is continued.

If the answer, however, is in the affirmative, then a new sequence is selected from a plurality of alternative sequences at block 850. The scan sequence may be selected such that the color bars or stripes are projected in a top-to-bottom or bottom-to-top manner. Similarly, the illumination scan sequence can be selected such that color bars or stripes are projected in a left-to-right, right-to-left, vertical or diagonal manner.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed. It is expressly intended that all combinations of those elements and/or method steps which perform substantially the same function in substantially the same way to achieve the same results are within the scope of the invention. Substitutions of elements from one described embodiment to another are also fully intended and contemplated.

What is claimed is:

1. A method for preventing copying of video images projected onto a screen, the method comprising the steps of:
a) selecting a scanning sequence from a plurality of predetermined scanning sequences;
b) projecting a plurality of colored light beams onto the screen concurrently with the images, in accordance with the selected scanning sequence, for a finite period of time; and
c) repeating steps a) and b) at least one time.

2. The method according to claim 1, wherein at least one of the scanning sequences in step a) includes scrolling the plurality of colored light beams.

3. The method according to claim 2, wherein the scrolling includes horizontal scrolling.

4. The method according to claim 2, wherein the scrolling includes vertical scrolling.

5. The method according to claim 2, wherein the scrolling includes diagonal scrolling.

6. The method according to claim 1, wherein at least one of the scanning sequences in step a) includes flashing the plurality of colored light beams.

7. The method according to claim 1, wherein the step c) is performed when a predetermined event occurs.

8. The method according to claim 7, wherein the predetermined event occurs in the images.

9. The method according to claim 8, wherein the predetermined event that occurs in the images is selectively placed into the images.

10. The method according to claim 1, wherein the selecting step is performed randomly.

11. The method of claim 1, wherein a scanning rate of at least one of the scanning sequences is selected based on a content of the projected image.

12. The method according to claim 8, wherein the predetermined event includes an aspect of the content in the image, the content of the image determining when a mark is to be placed in the images.

13. The method according to claim 8, wherein the predetermined event includes at least one of a predetermined level of a known color, a known image, a known period of time, and a mark selectively placed in the images.

14. A method for preventing copying of video images projected onto a screen, the method comprising the steps of:
a) selecting a scanning rate from a plurality of predetermined scanning rates;
b) projecting colored light beams onto the screen concurrently with the images, in accordance with the selected scanning rate, for a finite period of time; and
c) repeating steps a) and b) at least one time.

15. The method according to claim 14, wherein at least one of the selection of scanning sequences is a random selection.

16. The method of claim 14, wherein the scanning rate of at least one of the scanning sequences is selected based on the content of the projected image.

17. The method according to claim 14, wherein the step c) is performed when a predetermined event occurs.

18. The method according to claim 17, wherein the predetermined event occurs in the images.

19. The method according to claim 18, wherein the predetermined event that occurs in the images is selectively placed into the images.

20. The method according to claim 17, wherein the predetermined event includes an aspect of content in the image, the content of the image determining when a mark is to be placed in the images.

21. The method according to claim 17, wherein the predetermined event includes at least one of a predetermined level of a known color, a known image, a known period of time, and a mark selectively placed in the images.

22. An apparatus for preventing copying of video images projected onto a screen, the apparatus comprising:
a light source device for generating a plurality of colored light beams onto the screen concurrently with the images;
a processor for causing the light source to project the colored light beams onto the screen in accordance with a selected scanning sequence, for a finite period of time.

23. The apparatus according to claim 16, wherein the selected scanning sequence is made randomly.

24. The apparatus of claim 16, wherein a scanning rate of the scanning sequence is selected based on the content of the projected image.

25. The apparatus according to claim 22, wherein processor selects a different scanning sequence when a predetermined event occurs.

26. The apparatus according to claim 22, wherein the processor further causes the light source to project the colored light beams onto the screen in accordance with a randomly selected scanning rate, for a finite period of time.

27. The apparatus according to claim 26, wherein processor randomly selects a different scanning rate when a predetermined event occurs.

28. The apparatus according to claim 22, wherein the light source includes a plurality of light-emitting diodes, wherein at least two of the light-emitting diodes produce two different colors.
